(19) United States
(12) Patent Application Publication
(10) Pub. No.: US 2011/0154958 A1
(43) Pub. Date: Jun. 30, 2011

(54) DUAL-PURPOSE PLIERS ADAPTED TO CHAIN LINK

(76) Inventor: Wen-Pin WANG, An Ting Hsiang (TW)

(21) Appl. No.: 12/649,017

(22) Filed: Dec. 29, 2009

(51) Int. Cl. B25B 7/02; B25B 7/12

(52) U.S. Cl. 81/302; 81/427; 81/423; 81/426.5

(57) ABSTRACT

A dual-purpose pliers adapted to chain link applies to concurrently promote a separation of two first jaw parts or an approach of two second jaw parts, which is conducive to a convenient detachment or assemblage of a master chain link via merely using a driving tool. Further, each jaw part forms a curved brim represented by an arcuate contour, a serrated shape, or the combination thereof. Accordingly, the curved brim serves to encircle and lean against a periphery of a chain pin of the chain for a stable manipulation.

### BACKGROUND OF THE INVENTION

1. Field of the Invention

The present invention relates to a pliers adapted to chain link, in particular a tool adapting to detach master chain link of the bicycle chain.

2. Description of the Related Art

A conventional chain link of the bicycle chain commonly adds an exterior link plate and disposes respective annular grooves on either end or both ends of a chain pin. Concerning to the assembling, a C-shape buckling part is disposed relative to the exterior plate, by which the plate could be clasped on the annular groove to prevent the escape of the chain pin.

Further concerning to the detachment, the above typical invention needs to use specific tools to execute the dismantlement with following steps: initially fasten the chain link, force the exterior link plate to open, and thence extrude the chain pin out via a pusher. Such typical chain detacher is generally classified into IPC B21L 21/00.

As in a prior invention, FIG. 1 of ^{┌}KNUCKLE CONNECTOR FOR CONNECTING END KNUCKLES OF A CHAIN STRAND_{┘} published by U.S. Pat. No. 5,291,730, or another prior invention, FIG. 1 to FIG. 3 of ^{┌}MASTER CHAIN LINK_{┘} published by U.S. Pat. No. 5,362,282, mainly directed to a chain link configuration. It should note that nowhere professional or specific tools could be in normal to the detachment of such chain link. Instead, a commonly manual tool is well-known used to accomplish its detachment, for instance of a long flat nose pliers which could be utilized to forcedly propel the chain pin from the buckled groove into a free orifice. Similarly, to assemble this chain link, the same tool is also used for push the chain pin from the orifice into the groove. However, the typical master chain link facilely cause the chain pin slipped and inconvenient operation as a result of the pin formed of an arcuate contour that leads to the chain pin merely contacting with the jaw part of the pliers at one point.

Furthermore, the detachment and assemblage of the master chain link are totally contrary, namely the tool needs to clamp and compress the chain pin from outside toward inside for the detachment and in contrast, to force the space among chain pins open from inside toward outside for the assemblage. With regard to the well-known long flat nose pliers without elasticity essentially set by closing when in non-use and configured by crossly pivoting the left pliers body with the right one, it should be apparent to those skilled in the art that such design would require larger force for pulling the pin apart. In contrast, if the pliers is set by opening and configured by two parallel bodies that intersect at a middle portion, it may save more force accordingly, but two distinct pliers would be inevitably necessary for respectively dismantling and assembling the chain link.

Therefore, it is respectfully submitted that the typical invention is currently devoid of a distinct tool possessing dual-utilization in normal to detach and assemble the master chain link.

### SUMMARY OF THE INVENTION

Therefore, the object of the present invention is to solve the aforementioned problems and to provide a kind of dual-purpose pliers adapted to chain link, which particularly includes the structure of curved brims disposed on jaw parts of the pliers tip sections and preferably represents the curved brims into serrated contour. Accordingly, the curved brims could densely lean against an arcuate surface of the chain pin and thence provides at least one arch enclosure therearound, so as to improve and prevent the occurrence of slipped chain pin.

A preferred embodiment of the dual-purpose pliers in conformity with the present invention comprises a pliers handle, a first pliers body, and a second pliers body; wherein, the first pliers body connects with the pliers handle; further, the first pliers body has two first tip sections, and the first tip sections bend distal ends thereof to form two first jaw parts extending from the distal ends, respectively. At least one of the first jaw parts has a first curved brim defined thereon. Additionally, the second pliers body connects with the pliers handle. The second pliers body has two second tip sections, and the second tip sections bend distal ends thereof to form two second jaw parts extending from the distal ends, respectively. At least one of the second jaw parts has a second curved brim defined thereon. The two first jaw parts are subjected to open as well as two second jaw parts are subjected to close via constricting the pliers handle.

Preferably, the pliers handle includes two grasp portions, two fastening pins, a pivoting shaft, and a spring; each of the two grasp portions has one end thereof fixed by the fastening pin and pivotally engaged with the pivoting shaft at a place adjacent to the fastening pin. The spring disposed between the two grasp portions includes two opposite ends, and the two ends of the spring are separately positioned to the two grasp portions;

The first pliers body includes a first left-side pliers plate, a first right-side pliers plate, and a first pivoting pin; wherein, the first left-side and right-side pliers plates have respective first tip sections, and the first left-side pliers plate is coupled with the first right-side pliers plate by the first pivoting pin; a first orifice is defined between each of the first tip sections as well as the first pivoting pin, which allows the fastening pin of the pliers handle to penetrate through the first orifice to secure on the pliers handle. Each of the first tip sections is flexure at a distal end thereof for each first jaw part to stretch therefrom; at least one of the first jaw parts has the first curved brim defined thereon.

The second pliers body includes a second left-side pliers plate, a second right-side pliers plate, and a second pivoting pin; wherein, the second left-side pliers plate and right-side pliers plate have respective second tip sections as well as joint sections disposed reversely to the second tip sections.

The second left-side pliers plate is coupled with the second right-side pliers plate by the second pivoting pin.

Each of the joint sections as well as the second pivoting pin defines a second orifice formed therebetween, which allows the fastening pin of the pliers handle to penetrate through the second orifice to secure on the pliers handle; each of the second tip sections is flexure at a distal end thereof for each second jaw part to stretch therefrom; at least one of the second jaw parts has the second curved brim defined thereon.

A further preferred embodiment of the dual-purpose pliers in conformity with the present invention comprises a pliers handle and a pliers body; wherein, the pliers body connects with the pliers handle and has two opposite first tip sections and second tip sections. The first tip sections bend distal ends thereof to form two first jaw parts extending from the distal ends, respectively, and the second tip sections bend distal ends thereof to form two second jaw parts extending from the distal ends, respectively; the first jaw parts and the second jaw parts have at least one curved brim defined thereon, respectively, so that the two first jaw parts are subjected to separation at the same time the two second jaw parts suffers for close while constricting the pliers handle.

A further preferred embodiment of the dual-purpose pliers in conformity with the present invention comprises a pliers handle and two pliers bodies; the pliers handle serves to connect and drive the pliers bodies; wherein, the two pliers bodies have two opposite first tip sections and second tip sections. Between the first tip sections and the second tip sections, a connecting portion is disposed. The first tip sections respectively bend distal ends thereof to form two first jaw parts extending from the distal ends, and the second tip sections respectively bend distal ends thereof to form two second jaw parts extending from the distal ends. The first jaw parts of the first tip sections have at least one first curved brim defined thereon, and the second jaw parts of the second tip sections have at least one second curved brim defined thereon.

Preferably, the first jaw parts and the second jaw parts form respective curved brims thereon; the first curved brims on the first jaw parts are orientated in relation to contrary directions, and the second curved brims on the second jaw parts are disposed to face with each other.

Preferably, each of the curved brims is either formed in an arcuate shape, is shaped by a serrate structure, or is arranged in light of a combination of the arcuate shape and the serrate structure.

From above, in manipulation, users can grip the pliers handle to drive the two pliers bodies to dismantle the chain link and allow reversing the pliers handle to achieve the assemblage the chain link in light of the same driving manner.

Accordingly, the present invention has following advantages:
1. The present invention efficiently spends less time and saves more labors while in use.
2. The present invention represents the dual-function pliers, and so facilitates a convenient manipulation and attains favorable detachment and assemblage without extra tools.
3. The curved brims or serrated configuration defined on the jaw parts substantially leans against the chain pin to avert the slipping problem.

### BRIEF DESCRIPTION OF THE DRAWINGS

FIG. 1 is an exploded view showing a first preferred embodiment of the present invention;

FIG. 2 is a perspective view showing the first preferred embodiment of the present invention;

FIG. 3 is a perspective view showing the present invention reversing about 180 degrees reliant on FIG. 2; and

FIG. 4 is an exploded view showing a second preferred embodiment of the present invention;

FIG. 5 is a perspective view showing the second preferred embodiment of the present invention; and

FIG. 6 is a perspective view showing a third preferred embodiment.

### DETAILED DESCRIPTION OF THE PREFERRED EMBODIMENTS

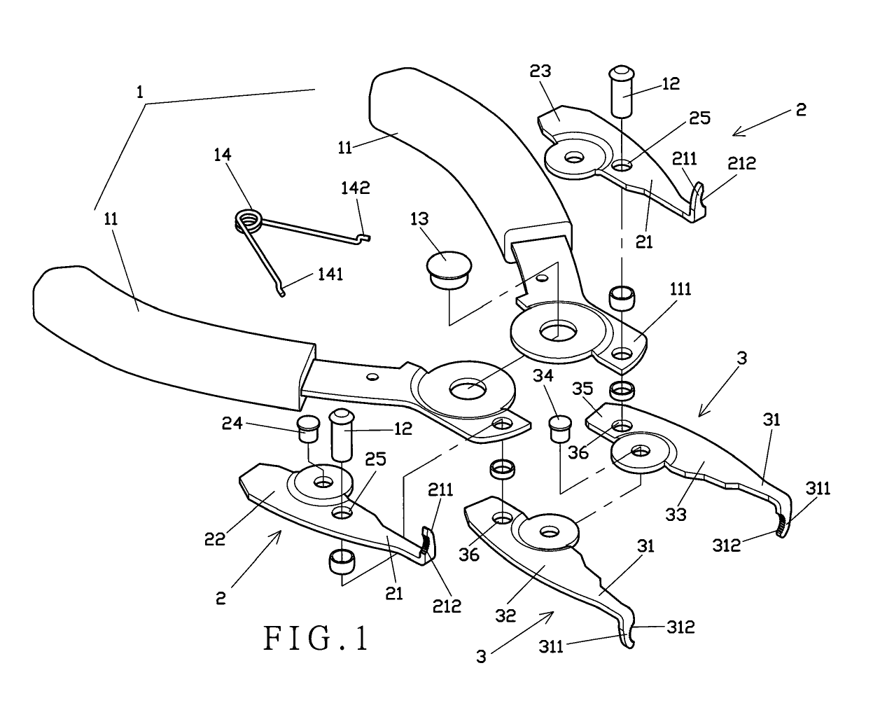

Referring to FIGS. 1 to 3, the dual-purpose pliers of the present invention comprises a pliers handle 1, a first pliers body 2, and a second pliers body 3. The first pliers body 2 connects with the pliers handle 1. The first pliers body 2 has two first tip sections 21, and the first tip sections 21 respectively bend distal ends thereof to form two first jaw parts 211 extending from the distal ends, so that the two first jaw parts 211 are subjected to separation via constricting the pliers handle 1. Furthermore, the second pliers body 3 connects with the pliers handle 1 as well. The second pliers body 3 has two second tip sections 31, and the second tip sections 31 bend distal ends thereof to form two second jaw parts 311 extending from the distal ends, respectively, whereby the two second jaw parts 311 are subjected to close via constricting the pliers handle 1. The aforementioned first jaw parts 211 and second jaw parts 311 respectively have first and second curved brims 212,312 defined thereon. The first curved brims 212 on the first jaw parts 211 are orientated in relation to contrary directions, and the second curved brims 312 on the second jaw parts 311 are disposed to face with each other. It is noted that each of the curved brims 212,312 could be either formed by an arcuate shape or a serrate structure disposed as labeled by 212,312. Alternatively, the curved brims 212,312 may be further configured into a combination of the arcuate shape and the serrate structure.

Still referring to FIGS. 1 to 3, the detail concatenation of interrelated elements of the subject dual-purpose pliers in accordance with a first embodiment of the present invention includes a pliers handle 1, a first pliers body 2, and a second pliers body 3. The pliers handle 1 has two grasp portions 11, two fastening pins 12, a pivoting shaft 13, and a spring 14. Each of the two grasp portions 11 has one end 111 thereof fixed by the fastening pin 12 and pivotally engaged with the pivoting shaft 13 at a place adjacent to the fastening pin 12. The spring 14 located between the two grasp portions 11 includes two opposite ends 141,142 separately fixed to the two grasp portions 11. Furthermore, the first pliers body 2 includes a first left-side pliers plate 22, a first right-side pliers plate 23, and a first pivoting pin 24. The first left-side pliers plate 22 and the right-side pliers plate 23 have respective first tip sections 21, and the first left-side pliers plate 22 is coupled with the first right-side pliers plate 23 by the first pivoting pin 24. Between each of the first tip sections 21 and the first pivoting pin 24, a first orifice 25 is defined, which allows the fastening pin 12 of the pliers handle 1 to penetrate through the first orifice 25 to secure on the pliers handle 1. Each of the first tip sections 21 is flexure at a distal end thereof for a first jaw part 211 to stretch therefrom, and every one of the first jaw parts 211 has a first curved brim 212 defined thereon. Herein, the two first curved brims 212 of the two first jaw parts 211 are orientated toward different directions. As to the second pliers body 3 includes a second left-side pliers plate 32, a second right-side pliers plate 33, and a second pivoting pin 34. The second left-side pliers plate 32 and the right-side pliers plate 33 have respective second tip sections 31 as well as joint sections 35 disposed opposite to the second tip sections 31. The second left-side pliers plate 32 is coupled with the second right-side pliers plate 33 by the second pivoting pin 34. Each of the joint sections 35 as well as the second pivoting pin 34 respectively defines a second orifice 36 formed therebetween, which allows the fastening pin 12 of the pliers handle 1 to penetrate through the second orifice 36 to secure on the pliers handle 1. Furthermore, each of the second tip sections 31 is flexure at a distal end thereof for a second jaw part 311 to extendably protrude therefrom, and every one of the second jaw parts 311 has a second curved brim 312 defined thereon. Herein, the second curved brims 312 of the two second jaw parts 311 are arranged to face with each other.

Similarly, it is noted that each of the curved brims 212,312 could be either formed by an arcuate shape or a serrate structure disposed as labeled by 212,312. Alternatively, the curved brims 212,312 may be further configured into a combination of the arcuate shape and the serrate structure.

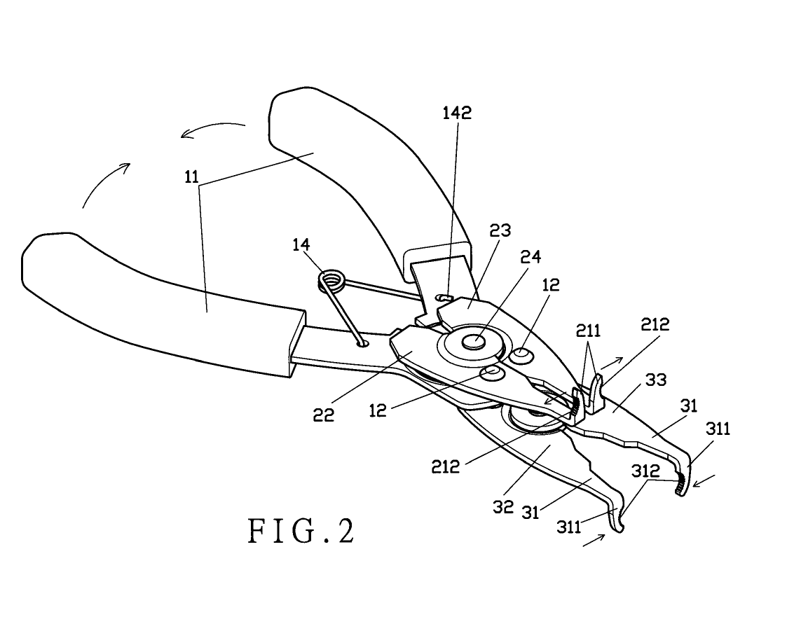

In use, the first jaw part 211 or the second jaw part 311 would be inserted into an interstice between chain pins of a bicycle chain link. As shown in FIG. 2, the grasp portions 11 of the pliers handle 1 gripped as arrowed drives the two first jaw parts 211 to be inserted into the chain pin of the chain link from downwards toward upwards. In view of the two first curved brims 212 faced toward opposite orientations, the interstice would be thence subjected to an enlargement; that being said, the first curved brims 212 serves to prop against the chain pin and thence forces to enlarge the interstice so that the chain pin could be pushed from a free orifice on the chain link toward a buckled groove for positioning. With regard to the detachment of the chain link, the two second jaw parts 311 are inserted into the chain pin of the link from upwards toward downwards. In view of the second curved brims 312 faced with each other, the interstice would be thence subjected to a clamping force so that the chain pin would escape from the buckled groove and enter into the free orifice for smoothly detaching or dismantling the chain pin from the link.

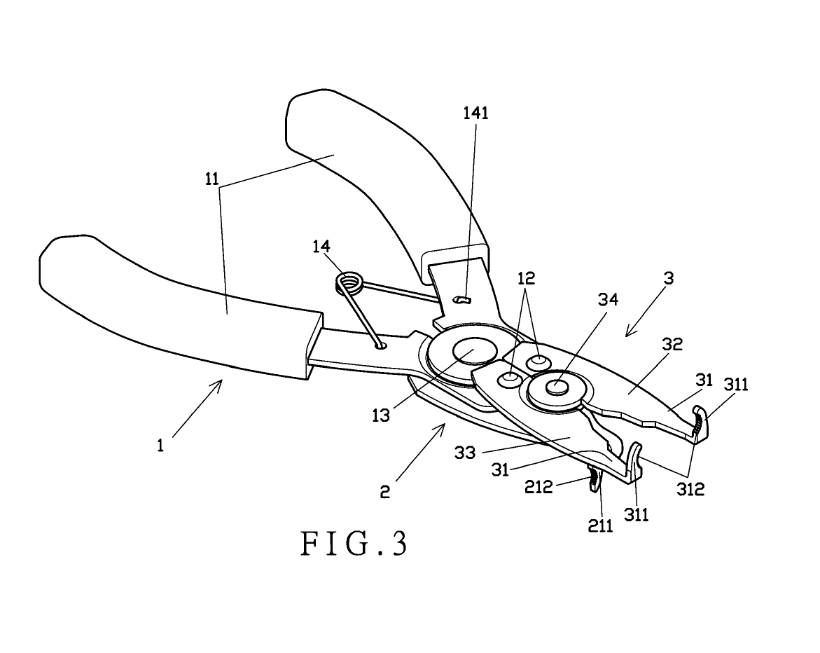

This embodiment may be used by reversing the pliers as shown in FIG. 3 for executing the dismantlement. Whereas, it should note that the second jaw part 311 should be inserted between the chain pins of the bicycle chain link from downwards toward upwards.

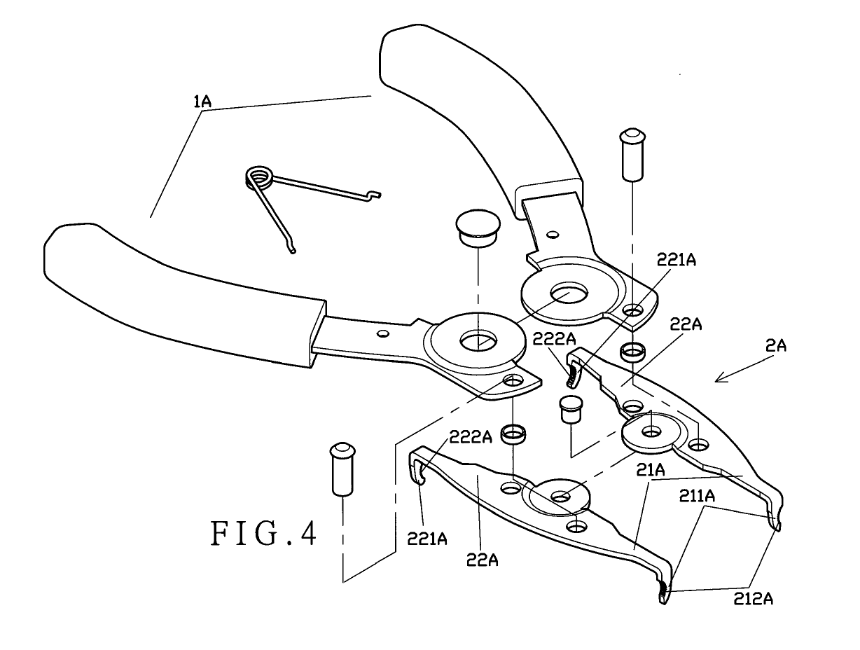

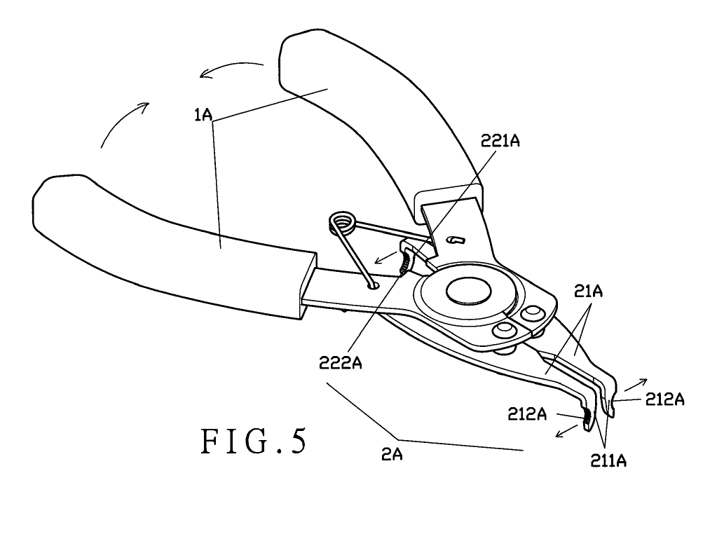

Referring to FIGS. 4 and 5, the dual-purpose pliers in accordance with a second embodiment of the present invention comprises a pliers handle 1A and a pliers body 2A; wherein, the pliers body 2A connects with the pliers handle 1A. Herein, the pliers body 2A, as it is, replaces the combination of the first pliers body 2 and the second pliers body 3 as described in the first embodiment. Wherein, the pliers body 2A has opposite first tip sections 21A and second tip sections 22A. The first tip sections 21A respectively bend distal ends thereof to form two first jaw parts 211A extending from the distal ends, and the second tip sections 22A respectively bend distal ends thereof to form two second jaw parts 221A extending from the distal ends, so that in case of constricting the pliers handle 1A, the two first jaw parts 211A would be subjected to separation accompanying with the close of the two second jaw parts 221A. The first jaw parts 211A and the second jaw parts 221A have respective curved brims 212A,222A defined thereon. The first curved brims 212A on the first jaw parts 211A are orientated in relation to contrary directions, and the second curved brims 222A on the second jaw parts 221A are disposed to face with each other. Furthermore, it is noted that each of the curved brims 212A,222A could be either formed by an arcuate shape or a serrate structure disposed as labeled by 212A,222A. Alternatively, the curved brims 212A,222A may be further configured into a combination of the arcuate shape and the serrate structure.

The operation of the second embodiment as shown in FIG. 5 is also executed by holding the grasp portions of the pliers handle 1A together with respect to the arrowed directions, so as to separate the two first jaw parts 211A and render the two second jaw parts 221A closed. The remaining procedures and actions are as the same as the first embodiment and herein are omitted.

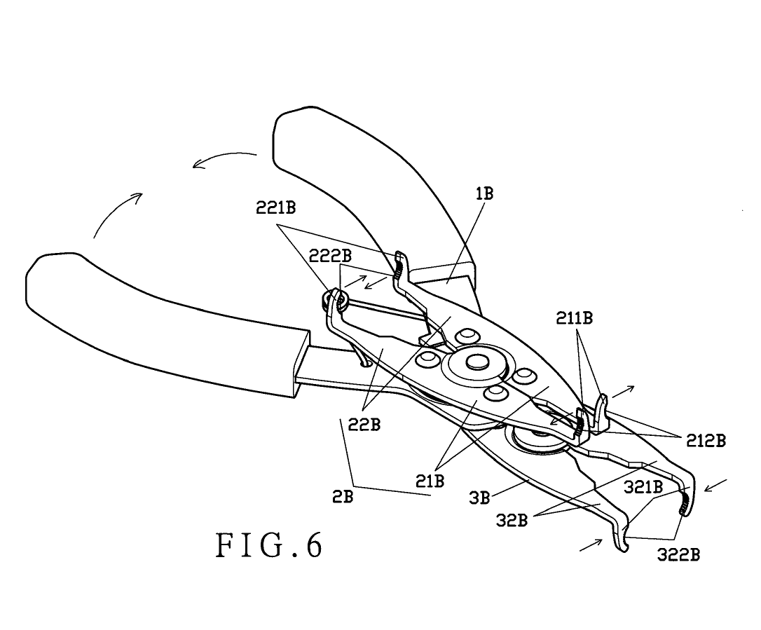

Referring to FIG. 6, the dual-purpose pliers in accordance with a third embodiment of the present invention comprises a pliers handle 1B and two pliers bodies 2B,3B. The pliers handle 1B serves to connect and drive the pliers bodies 2B,3B. The two pliers bodies 2B,3B have opposite first tip sections 21B and second tip sections 22B,32B. Herein, the first tip sections of the pliers body 3B are covered by the pliers body 2B and are not labeled in the figure. The second tip sections 22B,32B of two pliers bodies 2B,3B are arranged in adverse directions, and so are the first tip sections. The first tip sections 21B respectively bend distal ends thereof to form two first jaw parts 211B extending from the distal ends and forms respective first curved brims 212B thereon, and the second tip sections 22B,32B respectively bend distal ends thereof to form two second jaw parts 221B,321B extending from the distal ends and forms respective second curved brims 222B,322B thereon. Further, the first curved brims 212B on the first jaw parts 2113 are orientated in relation to contrary directions, and the second curved brims 222B,322B on the second jaw parts 221B,321B of the second tip sections 22B of the pliers bodies 2B,3B are disposed to face with each other.

Moreover, it is noted that each of the curved brims 212B,312B,222B could be either formed by an arcuate shape or a serrate structure disposed as labeled by 212B,312B,222B. Alternatively, the curved brims 2128,3128,2228 may be further configured into a combination of the arcuate shape and the serrate structure.

The operation of the third embodiment as shown in FIG. 6 is also executed by holding the grasp portions of the pliers handle 1B together with respect to the arrowed directions, so as to separate the two first jaw parts 211B and render the two second jaw parts 221B,321B closed. The remaining procedures and actions are as the same as the first preferred embodiment, whereas, this preferred embodiment herein is susceptible of a mutual contraposition by inward-outward and upward-downward reversing for attain various manipulating manners.

Accordingly, in manipulation, users can grip the pliers handle to drive the two pliers bodies to dismantle the chain link and allow reversing the pliers handle to achieve the assemblage the chain link in light of the same driving manner.

Further, the curved brims or serrated configuration defined on the jaw parts substantially leans against an arc surface of the chain pin without inducing the slipping problem. Additionally, users can merely utilize a single pliers to unconstrainedly dismantle and assemble the chain link without changing the tools, thereby increasing the convenience of utilization.

What is claimed is:

1. A dual-purpose pliers adapted to chain link, including:
a pliers handle;
a first pliers body connecting with said pliers handle; wherein, said first pliers body having two first tip sections, and said first tip sections bending distal ends thereof to form two first jaw parts extending from said distal ends, respectively; at least one of said first jaw parts having a first curved brim defined thereon; said two first jaw parts being subjected to separation via constricting said pliers handle; and
a second pliers body connecting with said pliers handle; wherein, said second pliers body having two second tip sections, and said second tip sections bending distal ends thereof to form two second jaw parts extending from said distal ends, respectively; at least one of said second jaw parts having a second curved brim defined thereon; said two second jaw parts being subjected to close via constricting said pliers handle.

2. The pliers as claimed in claim 1, wherein each of said first and second curved brims is either formed in an arcuate shape, is shaped by a serrate structure, or is arranged in light of a combination of said arcuate shape and said serrate structure.

3. The pliers as claimed in claim 1, wherein said two first jaw parts form first curved brims thereon and said two second jaw parts form second curved brims thereon; said first curved brims on said first jaw parts are orientated in relation to contrary directions, and said second curved brims on said second jaw parts are disposed to face with each other.

4. The pliers as claimed in claim 3, wherein each of said first and second curved brims is either formed in an arcuate shape, is shaped by a serrate structure, or is arranged in light of a combination of said arcuate shape and said serrate structure.

5. The pliers as claimed in claim 1, wherein said pliers handle includes two grasp portions, two fastening pins, a pivoting shaft, and a spring; each of said two grasp portions has one end thereof fixed by said fastening pin and pivotally engaged with said pivoting shaft at a place adjacent to said fastening pin; said spring includes two opposite ends; said spring is disposed between said two grasp portions, and said two ends of said spring are separately positioned to said two grasp portions;
said first pliers body includes a first left-side pliers plate, a first right-side pliers plate, and a first pivoting pin; wherein, said first left-side pliers plate and said right-side pliers plate have respective first tip sections, and said first left-side pliers plate is coupled with said first right-side pliers plate by said first pivoting pin; a first orifice being defined between each of said first tip sections and said first pivoting pin, allowable for penetrating said fastening pin of said pliers handle through said first orifice to secure on said pliers handle; each of said first tip sections is flexure at a distal end thereof for each of said two first jaw parts to stretch therefrom; at least one of said first jaw parts has said first curved brim defined thereon; and
said second pliers body includes a second left-side pliers plate, a second right-side pliers plate, and a second pivoting pin; wherein, said second left-side pliers plate and said right-side pliers plate have respective second tip sections and joint sections disposed opposite to said second tip sections;
said second left-side pliers plate is coupled with said second right-side pliers plate by said second pivoting pin; a second orifice is defined between each of said joint sections and said second pivoting pin, allowable for penetrating said fastening pin of said pliers handle through said second orifice to secure on said pliers handle; each of said second tip sections is flexure at a distal end thereof for each of said two second jaw parts to stretch therefrom; at least one of said second jaw parts has said second curved brim defined thereon.

6. The pliers as claimed in claim 5, wherein each of said first and second curved brims is either formed in an arcuate shape, is shaped by a serrate structure, or is arranged in light of a combination of said arcuate shape and said serrate structure.

7. The pliers as claimed in claim 5, wherein said two first jaw parts form first curved brims thereon and said two second jaw parts form second curved brims thereon; said first curved brims on said first jaw parts are orientated in relation to contrary directions, and said second curved brims on said second jaw parts are disposed to face with each other.

8. The pliers as claimed in claim 7, wherein each of said first and second curved brims is either formed in an arcuate shape, is shaped by a serrate structure, or is arranged in light of a combination of said arcuate shape and said serrate structure.

9. A dual-purpose pliers adapted to chain link, including:
a pliers handle; and
a pliers body connecting with said pliers handle; wherein, said pliers body having opposite first tip sections and second tip sections; said first tip sections bending distal ends thereof to form two first jaw parts extending from said distal ends, respectively, and said second tip sections bending distal ends thereof to form two second jaw parts extending from said distal ends, respectively; said first jaw parts and said second jaw parts having at least one curved brim defined thereon, respectively; said two first jaw parts being subjected to separation at the same time said two second jaw parts suffered for close in case of constricting said pliers handle.

10. The pliers as claimed in claim 9, wherein said curved brim is either formed in an arcuate shape, is shaped by a serrate structure, or is arranged in light of a combination of said arcuate shape and said serrate structure.

11. The pliers as claimed in claim 9, wherein said two first jaw parts form first curved brims thereon and said two second jaw parts form second curved brims thereon; said first curved brims on said first jaw parts are orientated in relation to contrary directions, and said second curved brims on said second jaw parts are disposed to face with each other.

12. The pliers as claimed in claim 11, wherein each of said first and second curved brims is either formed in an arcuate shape, is shaped by a serrate structure, or is arranged in light of a combination of said arcuate shape and said serrate structure.

13. A dual-purpose pliers adapted to chain link, including a pliers handle and two pliers bodies; said pliers handle serving to connect and drive said pliers bodies; wherein, said two pliers bodies having opposite first tip sections and second tip sections; a connecting portion being disposed between said first tip sections and said second tip sections; said first tip sections bending distal ends thereof to form two first jaw parts extending from said distal ends, respectively, and said second tip sections bending distal ends thereof to form two second jaw parts extending from said distal ends, respectively; said first jaw parts of said first tip sections having at least one first curved brim defined thereon, and said second jaw parts of said second tip sections having at least one second curved brim defined thereon.

14. The pliers as claimed in claim 13, wherein each of said first and second curved brims is either formed in an arcuate shape, is shaped by a serrate structure, or is arranged in light of a combination of said arcuate shape and said serrate structure.

15. The pliers as claimed in claim 13, wherein said two first jaw parts form first curved brims thereon and said two second jaw parts form second curved brims thereon; said first curved brims on said first jaw parts are orientated in relation to contrary directions, and said second curved brims on said second jaw parts are disposed to face with each other.

16. The pliers as claimed in claim 15, wherein each of said first and second curved brims is either formed in an arcuate shape, is shaped by a serrate structure, or is arranged in light of a combination of said arcuate shape and said serrate structure.
